(19) United States
(12) Patent Application Publication
(10) Pub. No.: US 2003/0044245 A1
(43) Pub. Date: Mar. 6, 2003

(54) BRUSH RING SEAL FOR PNEUMATIC TRANSFER CARRIERS

(76) Inventor: John Michael Power, Garland, TX (US)

Correspondence Address: John Michael Power, Suite 600, 2118 Wall Street, Garland, TX, 75041-4057, US

(21) Appl. No.: 09/940,138

(22) Filed: Aug. 28, 2001

(51) Int. Cl. B65G 51/06

(52) U.S. Cl. 406/190

(57) ABSTRACT

A simple but effective concept of using nylon, polypropylene or other flexible filament 2 as brush to create ring seals for pneumatic transfer carriers, thus affecting a virtually air tight seal 6 as well as superior durability due to the low coefficient of friction between the plastic brush filament and the conduit 7 through which it passes.

### BACKGROUND—FIELD OF INVENTION

This invention relates to ring air seals for increasing efficiency and durability of pneumatic transfer systems carriers. It applies to all pneumatic systems by offering new carriers with the invention installed and/or retro-fit carriers wherein existing seals are replaced with the invention.

### BACKGROUND—DESCRIPTION OF PRIOR ART

Pneumatic transfer systems have been in use in retail, industrial, banking and other applications for more than a century. Their load-carrying components, usually cylinders, have always relied on leather, felt, rubber and more recently, composite materials to affect a seal between the carrier and inner wall of the system's transfer tubes.

All such seals have diameters a fraction of an inch smaller than the inside of the tube to avoid drag and allow easy travel. This gap causes a loss of air pressure; reducing its efficiency and limiting its load carrying capacity.

The outer edges of seals (such as those on carriers in use at bank drive-up tellers) have a tendency to deteriorate from contact with the conduit's interior. They often chip at their edges due to the material fatigue generated by the back and forth pressures they experience.

### OBJECTS AND ADVANTAGES

Accordingly, several objects and advantages of the present invention are:

(a.) To provide an air-tight yet fully flexible air seal for use on pneumatic transfer vehicles,

(b.) To provide a seal that cannot crack, chip nor lose its air-sealing function, under severe and long-term use,

(c.) To provide a seal that, through superior air blocking facility, will significantly increase the load carrying capacity of the systems in which weight is a factor.

(d.) To provide a seal whose coefficient of friction is very low, thus facilitating a smooth and drag-free passage through the host system.

(f.) To provide a seal that will allow its transfer host to negotiate turns and bends in the pneumatic system with greater ease and without loss of air/vacuum pressure.

### IMPROVED AIR RING SEAL FOR PNEUMATIC CARRIERS

This invention relates to an improved air seal for pneumatic systems and devices; including but not limited to the type used to transport documents and objects. These bank, office and warehouse systems, as examples, utilize vacuum and/or positive pressure within a conduit or tube through which the conveyance or object is propelled. A primary component of such a system is the air seal and its integrity, as high volumes of air are applied. This integrity bears greatly upon both the speed of the object so propelled and the load carrying capacity for which it was designed.

The invention creates an air-tight but flexible seal between the object and the wall of the tube or other conduit, by means of a strip brush formed to occupy whatever space is created between the object and the conduit's inside wall.

The outside diameter of the invention, is greater than the inside diameter of the conduit, thus causing the outer end of its brush filament to press against the inside wall of the tube; to lie tangentially and parallel to the wall in its travel. Its low coefficient of friction allows a firm pressure with minimum drag. Any such drag would be overcome by the increased efficiency of the air's force applied to the carrier.

The invention permits 99% or more of the vacuum or positive pressure generated within the conduit to apply motivational force on the object at all times.

The invention's area of flexibility between the object and interior surfaces of the conduit, allows a pneumatic transfer system's radiused turns to be tighter and occupy less space than those using semi-rigid air seals.

The invention eliminates the possibility of air loss from fractures, chipping or abrasion often experienced by semi-rigid ring seals.

The invention is initially intended for application on commercial pneumatic transfer systems, but it has many potential uses as a seal, wherever maximum efficiency is required on pressure-impelled objects.

All important objects and advantageous features of the invention will be apparent from the following description and drawings: wherein, for illustration purposes only, a specific form of the invention is set forth in detail:

### DRAWING FIGURES

FIG. 1 depicts an end view of the invention as it appears in a circular form as an air seal to fit a cylindrical pneumatic carrier. The invention will also be configured in appropriate instances into rectangular seals to accommodate certain high capacity industrial pneumatic carriers. The numeral 1 designates a point at which the ends of the strip brush are brought together to complete the ring.

FIG. 1a depicts an enlarged side view of the brush in its linear (strip) form as manufactured, and before it is formed into a ring, which is the final configuration of the invention. The high concentration of filament (about 1,200 per inch) allows the brush to be splayed outward in forming the ring, without losing sealing density, as seen in FIG. 1.

FIG. 1b is an enlarged cross section drawing of the brush, illustrating its method of construction: Specifically, the manner in which the filament, designated by the numeral 2, is wrapped around a wire mandrel, as designated by the numeral 5. The brush, thus gathered, is crimped into a steel channel or backing, as designated by the numeral 4.

FIG. 2 is a side view of the invention installed in a generic depiction of a cylindrical pneumatic carrier. This view depicts the manner in which the brush filaments exceed the outside diameter of the carrier as designated by the numeral 6 and the inside diameter of the transfer tube, seen as the numeral 7. This view shows the manner in which the invention will be installed behind the end-cap.

FIG. 2a is an enlarged sectional depiction of the detail contained in the dotted circle of FIG. 2. This illustrates the brush compressed against the inside of the conduit or tube of the pneumatic system. Numeral 7 describes the wall of the tube, while numeral 6 shows how the brush, being larger than the inside dimension of said tube, is bent to create a tight but flexible seal. The numeral 8 points to a generic depiction of the components of the carrier that would hold the brush in place.

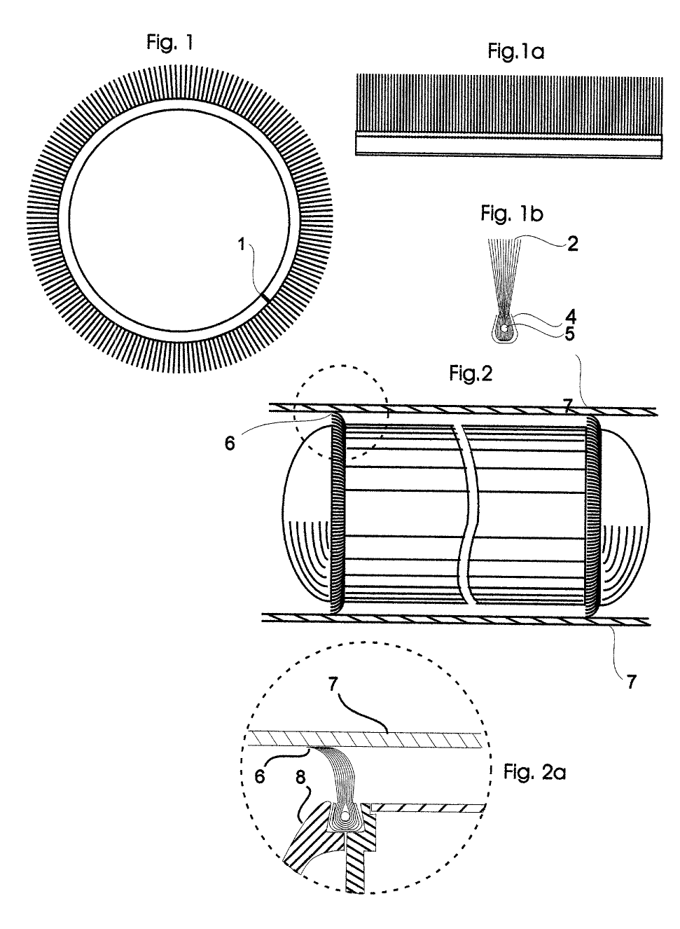

What is claimed as new is:

1. The application of ring seals in the form and material of a brush, to pneumatic transfer modules to form a superior seal to fully utilize the forces of vacuum or positive air pressure on such devices, to move them swiftly and efficiently through their conduits.

2. That the invention provides a vastly increased seal integrity, through which little or no air pressure or vacuum is lost when applied to the device.

3. That the invention requires no clearance between the air ring and the inner wall of the conduit.

4. That the invention provides superior load carrying capacity of the carrier, due to its more efficient seal and greater utilization of applied vacuum or positive air pressure.

5. That the invention has the unique ability to clean its conduit as it travels.

6. That the invention may be applied to a variety of applications and uses such as an air seal to increase the efficiency of projectiles by way of its superior pressure containment qualities. And that the compounds and materials available for the brush filament, allow for a wide range of experimental devices exploiting the efficiency and durability of brush as an air seal.
